(19) United States
(12) Patent Application Publication
(10) Pub. No.: US 2025/0061735 A1
(43) Pub. Date: Feb. 20, 2025

(54) IMAGE PROCESSING METHOD AND RELATED DEVICE

(71) Applicant: SAMSUNG ELECTRONICS CO., LTD., Suwon-si (KR)

(72) Inventors: Zhuoxin GAN, Beijing (CN); Yingying Jiang, Beijing (CN); Inho Choi, Suwon-si (KR); Weihua Zhang, Beijing (CN); Yong A, Beijing (CN)

(73) Assignee: SAMSUNG ELECTRONICS CO., LTD., Suwon-si (KR)

(21) Appl. No.: 18/932,067

(22) Filed: Oct. 30, 2024

Related U.S. Application Data
(63) Continuation of application No. PCT/KR2023/006913, filed on May 22, 2023.

(30) Foreign Application Priority Data
Jun. 15, 2022 (CN) 202210682096.9

(51) Int. Cl. G06V 20/70; G06V 10/26; G06V 10/74; G06V 10/77; G06V 10/82

(52) U.S. Cl. CPC G06V 20/70; G06V 10/267; G06V 10/761; G06V 10/7715; G06V 10/82

(57) ABSTRACT

An image processing method includes obtaining a target image; splitting the target image into at least one sub-image based on a similarity of complexity in the target image; processing the at least one sub-image by at least one decoder corresponding to the at least one sub-image; and obtaining an output image based on the processed at least one sub-image. The splitting of the target image into the at least one sub image includes: splitting the target image into at least one grid of equal size; determining a similarity of complexity between adjacent grids in the at least one grid; and grouping the at least one grid into the at least one sub-image based on the similarity of the complexity between the adjacent grids.

### CROSS-REFERENCE TO RELATED APPLICATION(S)

This application is a continuation of International Application No. PCT/KR2023/006913, filed on May 22, 2023, in the Korean Intellectual Property Receiving Office, which is based on and claims priority to Chinese Patent Application No. 202210682096.9, filed on Jun. 15, 2022, with the China National Intellectual Property Administration, the disclosures of which are incorporated by reference herein in their entireties.

### BACKGROUND

### 1. Field

The present application relates to the field of artificial intelligence technologies, and in particular, the present application relates to an image processing method and related device.

### 2. Description of Related Art

Semantic segmentation refers to classifying each pixel in an image, and this technology can be applied to fields such as medical images and unmanned driving.

In the related art, feature maps with same high-resolution and a decoder are used for respective regions of an input image to perform segmentation prediction, however, processing with a high-resolution feature map for an image with massive simple regions (e.g., sky, road, buildings, etc.) consumes massive computing resources, that is, there is a problem of low resource utilization efficiency.

### SUMMARY

The embodiments of the present application provide an image processing method and related device, which may solve the problem of low resource utilization efficiency of image processing. The technical solutions are as follows:

According to an embodiment of the disclosure, an image processing method may include: obtaining a target image; splitting the target image into at least one sub-image based on a similarity of complexity in the target image; processing the at least one sub-image by at least one decoder corresponding to the at least one sub-image; and obtaining an output image based on the processed at least one sub-image.

The splitting of the target image into the at least one sub image may include: splitting the target image into at least one grid of equal size; determining the similarity of the complexity between adjacent grids among the at least one grid; and grouping the at least one grid into the at least one sub-image based on the similarity of the complexity between the adjacent grids.

The determining the similarity of the complexity between the adjacent grids may include: obtaining feature information associated with a position of a fine object by performing convolution on the target image; and determining the similarity of the complexity between the adjacent grids based on the feature information and self-attention network.

The feature information may include a mask map indicating at least one of a location of an easily-lost region, and fine feature maps indicating fine features of the target image.

The grouping the at least one grid into the at least one sub-image may include: identifying whether the similarity of the complexity of the adjacent grids is greater than or equal to a threshold; identifying whether a shape obtained by merging the adjacent grids is a rectangle based on identifying that the similarity of the complexity between the adjacent grids is greater than or equal to the threshold; and grouping the adjacent grids based on the shape being a rectangle.

The processing the at least one sub-image may include: determining encoding information corresponding to each of the at least one sub-image; and determining network information for the at least one decoder corresponding to each of the at least one sub-image based on the encoding information.

The network information may include at least one of an output resolution, a number of layers, and a number of channels of network.

The encoding information may include at least one of a pooling feature, a semantic probability distribution feature, and a shape feature of the at least one sub-image.

The obtaining the feature information associated with the position of the fine object may include: performing a convolution operation on the target image based on convolution kernels corresponding to each direction, where the each direction for the convolution kernels are determined based on information of adjacent points to a center point of the convolution kernels.

According to an embodiment of the disclosure, an electronic device for image processing may include: a memory storing one or more instructions; and at least one processor configured to execute the one or more instructions to: obtain a target image; split the target image into at least one sub-image based on a similarity of complexity in the target image; process the at least one sub-image by at least one decoder corresponding to complexity of the at least one sub-image; and obtain an output image based on the processed at least one sub-image.

The at least one processor may be further configured to: split the target image into at least one grid of equal size; determine the similarity of the complexity between adjacent grids among the at least one grid; and group the at least one grid into the at least one sub-image based on the similarity of the complexity between the adjacent grids.

The at least one processor may be further configured to: obtain feature information associated with a position of a fine object by performing convolution on the target image; and determine the similarity of the complexity between the adjacent grids based on the feature information and a self-attention network.

The at least one processor may be further configured to: determine encoding information corresponding to each of the at least one sub-image; and determine network information for the at least one decoder corresponding to each of the at least one sub-image based on the encoding information.

The at least one processor is further configured to: perform a convolution operation on the target image based on convolution kernels corresponding to each direction, where the each direction of the convolution kernels is determined based on information of adjacent points and a center point of the convolution kernels.

According to an embodiment of the disclosure, a non-transitory computer-readable storage medium storing a computer program configured to execute an image processing method, where the image processing method includes: obtaining a target image; splitting the target image into at least one sub-image based on a similarity of complexity in the target image; processing the at least one sub-image by at least one decoder corresponding to the at least one sub-image; and obtaining an output image based on the processed at least one sub-image.

### BRIEF DESCRIPTION OF DRAWINGS

The above and other aspects, features, and advantages of certain embodiments of the present disclosure will be more apparent from the following description taken in conjunction with the accompanying drawings, in which:

FIG. 1 is a schematic diagram of image semantic segmentation in the related art;

FIG. 2 is a processing flow chart of performing image semantic segmentation in the related art;

FIG. 3 is a schematic diagram of a simple region in image semantic segmentation;

FIG. 4A is an effect diagram of image semantic segmentation in the related art;

FIG. 4B is an effect diagram of image semantic segmentation in the related art;

FIG. 5 is a schematic flowchart of an image processing method according to an embodiment of the disclosure;

FIG. 6 is an overall flowchart according to an embodiment of the disclosure;

FIG. 7 is a schematic diagram of an easily-lost region detector according to an embodiment of the disclosure;

FIG. 8 is a schematic diagram of performing image processing based on position-aware convolution according to an embodiment of the disclosure;

FIG. 9 is a schematic diagram of a position-aware convolution group according to an embodiment of the disclosure;

FIG. 10 is a schematic diagram of a predictor-based dynamic decoder network according to an embodiment of the disclosure;

FIG. 11 is a schematic diagram of dynamic generation of a sub-image according to an embodiment of the disclosure;

FIG. 12 is a schematic diagram of the function of an easily-lost region mask according to an embodiment of the disclosure;

FIG. 13 is a schematic diagram of a predictor according to an embodiment of the disclosure;

FIG. 14 is a schematic diagram of a region of pole according to an embodiment of the disclosure;

FIG. 15 is a schematic structural diagram of an image processing apparatus according to an embodiment of the disclosure;

FIG. 16 is a schematic structural diagram of an electronic device according to an embodiment of the disclosure; and

FIG. 17 is a flow diagram according to an embodiment of the disclosure.

### DETAILED DESCRIPTION

Embodiments of the disclosure are described below in conjunction with the accompanying drawings in the disclosure. It should be understood that the embodiments described below in conjunction with the accompanying drawings are exemplary descriptions for explaining the technical solutions of the embodiments of the disclosure, and do not limit the technical solutions of the embodiments of the disclosure.

Those skilled in the art will understand that the singular forms “a”, “an”, “said” and “the” as used herein may also include plural forms unless expressly stated. It should be further understood that the terms “includes,” “comprises,” “has,” “having,” “including,” and/or “comprising,” used in the embodiments of the disclosure mean that corresponding features may be implemented as presented features, information, data, steps, operations, elements and/or components, but do not exclude implementations of other features, information, data, steps, operations, elements, components, and/or combinations thereof, etc., as supported in the art. It will be understood that when referring to an element as being “connected” or “coupled” to another element, the one element can be directly connected or coupled to the other element, or the one element and the other element may be intervening through intervening elements to establish a connection relationship. In addition, as used herein, “connected” or “coupled” may include a wireless connection or wireless coupling. The term “and/or” as used herein indicates at least one of the items defined by the terms, e.g., “A and/or B” can be implemented as “A”, or as “B”, or as “A and B.”

As used herein, each of the expressions “A or B,” “at least one of A and B,” “at least one of A or B,” “A, B, or C,” “at least one of A, B, and C,” and “at least one of A, B, or C,” may include one or all possible combinations of the items listed together with a corresponding expression among the expressions.

In order to make the purpose, technical solution and advantages of this application clearer, the following will further describe embodiments of the disclosure in detail with reference to the accompanying drawings.

The disclosure relates to the technical field of artificial intelligence (AI), which is a theory, method, technology and application system to use digital computer or digital computer-controlled machine to simulate, extend and expand human intelligence, perceive environment, acquire knowledge and use knowledge to obtain the best results. In other words, artificial intelligence is a comprehensive technology of computer science that attempts to understand the essence of intelligence and produce a new kind of intelligent machine that can respond in a similar way to human intelligence. Artificial intelligence is to study the design principles and implementation methods of various intelligent machines, so that the machines have the functions of perception, reasoning and decision-making. Artificial intelligence technology is a comprehensive discipline, involving a wide range of fields, including both hardware-level technology and software-level technology. The basic technologies of artificial intelligence generally include technologies such as sensors, special artificial intelligence chips, cloud computing, distributed storage, big data processing technology, operation/interaction systems, mechatronics, etc. Artificial intelligence software technologies mainly include computer vision technology, speech processing technology, natural language processing technology, and machine learning/deep learning, autonomous driving, smart transportation, etc.

This application may relate to computer vision (CV) technology. CV is a science that studies how to enable a machine to “see”, and to be specific, to implement machine vision such as recognition, measurement, and the like for a target by using a camera and a computer in replacement of human eyes, and further perform graphic processing, so that the computer processes the target into an image more suitable for human eyes to observe, or more suitable to be transmitted to an instrument for detection. As a scientific discipline, CV studies related theories and technologies and attempts to establish an AI system that can obtain information from images or multidimensional data. The CV technologies generally include technologies such as image processing, image recognition, image semantic understanding, image retrieval, optical character recognition (OCR), video processing, video semantic understanding, video content/behavior recognition, three-dimensional object reconstruction, a 3D technology, virtual reality, augmented reality, synchronous positioning and map construction, autonomous driving, smart transportation and other technologies, and further include biometric feature recognition technologies such as common face recognition and fingerprint recognition.

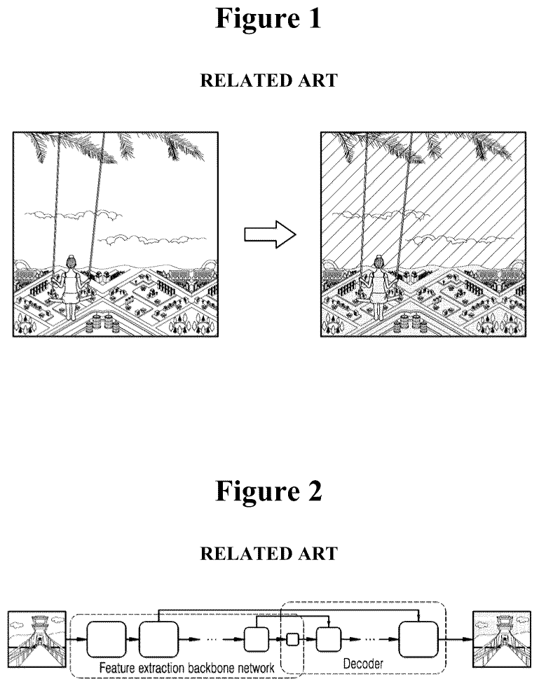

In embodiments of the disclosure, it may make improvements for the technical problems existing in semantic segmentation of images. Even if it is not semantic segmentation of images, it can improve technical problems in the field of computer vision. For example, semantic segmentation may refer to predicting the semantic category of each pixel in an input image and assigning a semantic label to each pixel. As shown in FIG. 1, sky regions and non-sky regions in the image are segmented.

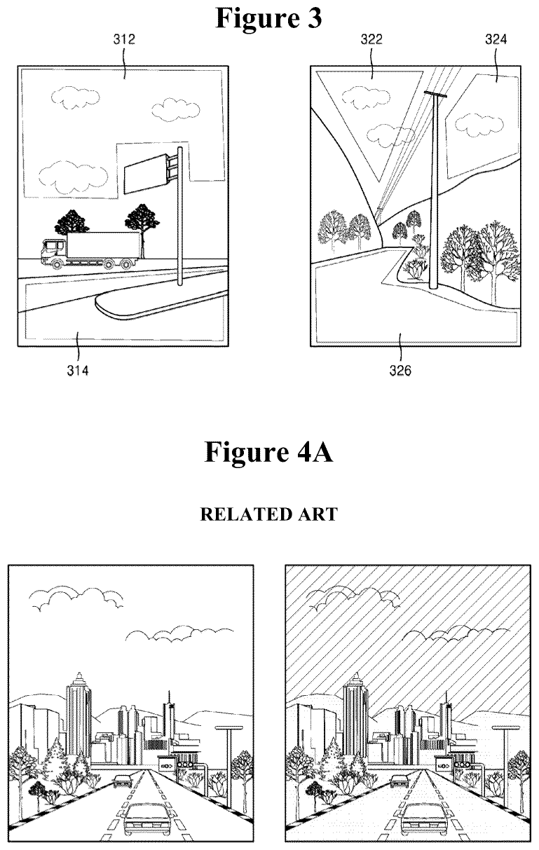

In the related art, as shown in FIG. 2, for the input image, visual features are extracted through a backbone network, in which feature maps as the resolution is reducing are successively generated at different specific depths along with the backbone network, and these feature maps, although reduced in resolution, have more high-level semantic information. Subsequently, the feature map with the lowest resolution is gradually restored to a map with larger resolution by combining with the feature map with larger resolution extracted by shallower layers of the backbone network, through a decoder. Wherein, for each region of the input image, this scheme may use the same high-resolution feature map and a decoder with fixed structure and resolution (such as 4 layers, 256 channels, ¼ resolution) for segmentation prediction. However, for large simple regions (312, 314, 322, 324, 326) in the image (such as sky, roads, buildings, etc., as shown by the irregular boxes in FIG. 3), using high-resolution feature maps for processing is very computationally intensive, that is, there is a problem of poor resource allocation.

For the above-mentioned at least one technical problem existing in the related art or defects to be improved, the disclosure provides an image processing method, apparatus, electronic device, computer-readable storage medium, and computer program product. One or more embodiments of the disclosure may segment the parts of the target image with similar complexity in semantic segmentation into the at least one grid with equal size, and then use different decoders for at least one sub-image to determine their corresponding semantic segmentation results, and determine the semantic segmentation result for the target image according to the semantic segmentation results for the at least one sub-image, which may significantly improve resource utilization efficiency of the semantic segmentation for the target image and reduce unnecessary waste of resources.

Hereinafter, by describing several exemplary embodiments, the technical solutions of the embodiments of the disclosure and the technical effects of the technical solutions of the disclosure will be described. It should be noted that the following embodiments may be referred to, learned from, or combined with each other, and the same terms, similar features, and similar implementation steps in different embodiments will not be described repeatedly.

FIG. 5 shows a schematic flowchart of an image processing method according to an embodiment of the disclosure. The method may be executed by any electronic device, such as a terminal or a server. The terminal can be a smart phone, a tablet computer, a notebook computer, a desktop computer, a smart speaker, a smart watch, a vehicle-mounted device, and the like. The server may be: an independent physical server; a server cluster or a distributed system composed of multiple physical servers; or a cloud server providing infrastructure cloud computing service such as a cloud service, cloud database, cloud computing, cloud function, cloud storage, network service, cloud communication, intermediate service, domain name service, security service, CDN, and big data and artificial intelligence platform, but not limited to these.

An age processing method is provided in the embodiment of the disclosure, and the method may be applied to scenarios such as medical image and unmanned driving. This method includes step S101-step S104.

Step S101: acquiring a target image.

Wherein, for different application scenarios, different target images can be obtained and processed; for example, in the field of intelligent driving, frame images at a specified time point can be obtained from a driving recorder for processing; and for example in the medical field, specific images output by a detection device may be obtained and processed.

Step S102: splitting the target image to obtain at least one sub-image.

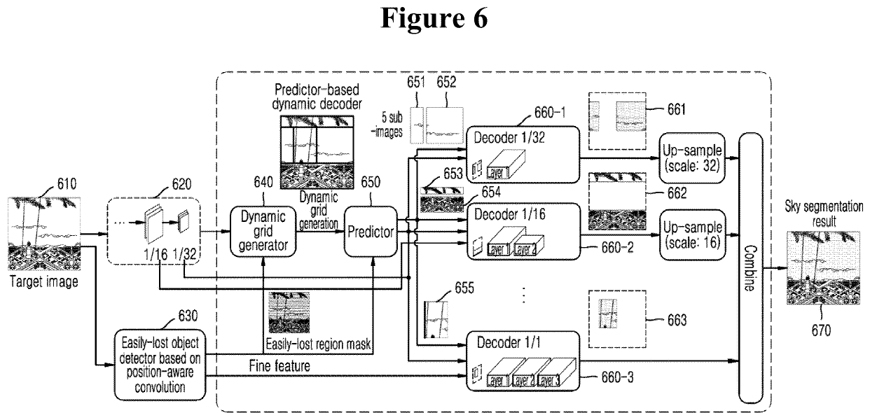

Feature information that characterizes an object can be included in the target image. For example of the target image as shown in FIG. 6, the feature map corresponding to the target image may include feature information related to sky, character, swing, tree, and the like, and the feature information may include position information representing where respective objects are located, detailed information of objects, and the like. On this basis, the feature information can be used to determine the difficulty of semantic segmentation, and the target image can be split based on the difficulty of semantic segmentation. For example, parts with similarity difficulties of semantic segmentation may be segmented into the same sub-image, to split the target image into regions (sub-images) which may have different sizes and aspect ratios wherein each region may be irregular or regular. Optionally, as shown in FIG. 6, in order to reduce computational complexity and resource consumption, the target image may be split into rectangular regions with different sizes and aspect ratios (corresponding to the five sub-images shown in FIG. 6). Wherein, the difficulty level of semantic segmentation can be divided into several levels, such as simple, medium, and complex levels according to the number of objects and detailed information included therein. For example, if the sub-image obtained by splitting includes only one kind of objects, it can be determined as a simple level; if it includes two kinds of objects, it can be determined as a medium level; if it includes more than two kinds of objects, it can be determined as a complex level.

Step S103: determining a semantic segmentation result for a sub-image by a target decoder matching the sub-image.

Considering that the complexity of the content shown in different sub-images is different, decoders for different resolutions and/or different network structures (such as different layers, different channel numbers) can be used to predict semantic segmentation results for respective sub-images, to better allocate resources and effectively balance the performance and resource overhead of semantic segmentation.

Step S104: determining a semantic segmentation result for the target image based on the semantic segmentation result for the sub-image.

Each sub-image corresponds to a semantic segmentation result, and therefore, the semantic segmentation result for the entire target image can be obtained by combining the corresponding semantic segmentation results of respective sub-images, as shown in FIG. 6.

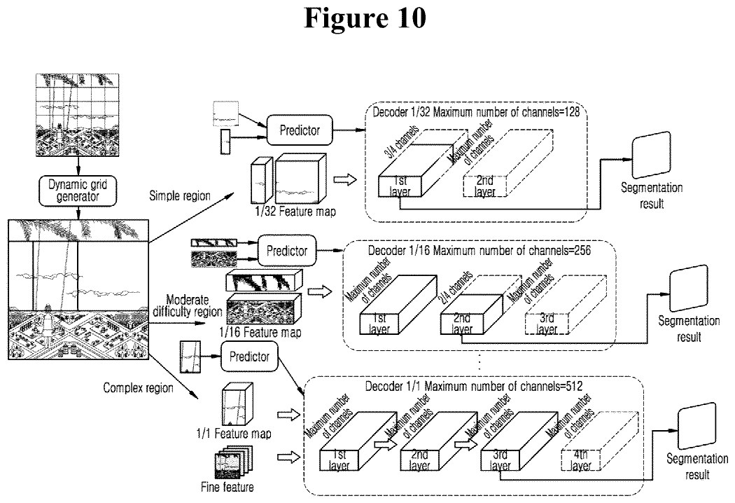

Adapted to the above-mentioned steps S101-step S104, the embodiment of the disclosure provides a Predictor-based Dynamic Decoder network (as shown in FIG. 6), which adopts, by a dynamic network, matching output resolutions and decoder networks for different sub-images with different segmentation difficulties (as referred to as semantic segmentation difficulties). The predictor-based dynamic decoder network includes a dynamic grid generator, a predictor, and a weight-sharing decoder network, as shown in FIG. 6 and FIG. 10. The dynamic decoder network provided by the embodiment of the disclosure firstly uses the dynamic grid generator to split the target image to be split into rectangular regions (sub-images) with different sizes and aspect ratios according to the degrees of segmentation difficulties, wherein for same rectangular region, it may be considered as the same segmentation difficulty for all pixels in the region; and then the sub-images can be used as a whole to be fed into the predictor, and the predictor may specify output resolutions and depths and widths of corresponding decoders (network structure), required for the sub-images. For a sub-image of which segmentation difficulty is simple, the embodiment of the disclosure uses a feature map with a lower output resolution and a simpler sub-decoder in the corresponding decoders to perform image semantic segmentation; for a sub-image of which segmentation difficulty is relatively complex, the embodiment of the disclosure uses a feature map with a higher output resolution and all or more complex sub-decoders of the corresponding decoders to perform image semantic segmentation. In the above schemes, the embodiment of the disclosure solves the problem of resource waste caused by using high resolution and complex decoders to perform semantic segmentation for images with simple segmentation difficulty.

The specific process for extracting the feature information of the target image in the embodiment of the disclosure will be described below.

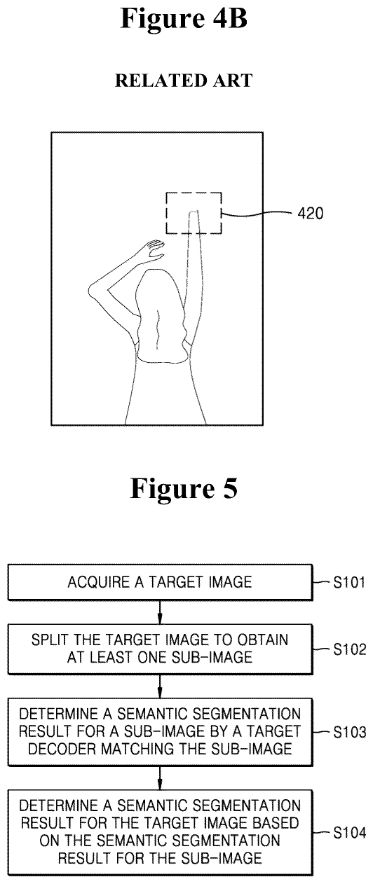

In an embodiment of the disclosure, considering that since the backbone network for extracting features has down-sampling characteristics, and the resolution of feature maps with higher semantic information is gradually reduced. Although the resolution of feature maps with higher semantic information may be relatively recovered to a certain extent by combining a feature map with higher resolution into the decoder, such recovery is incomplete (due to that the combined feature maps with higher resolution usually have weaker semantic information), thus, small objects and object edges are particularly easily-lost in segmentation results by a semantic segmentation method in the related art. For example, in the semantic segmentation result for sky shown in FIG. 4a, the segmentation effect of finer objects (such as street lamps, street signs, etc.) is poor; as shown in FIG. 4b, the segmentation result of the person's palm part (420) is poor. Detailed features of person's palm part (420) may disappear during computer vision processing (for example, semantic segmentation).

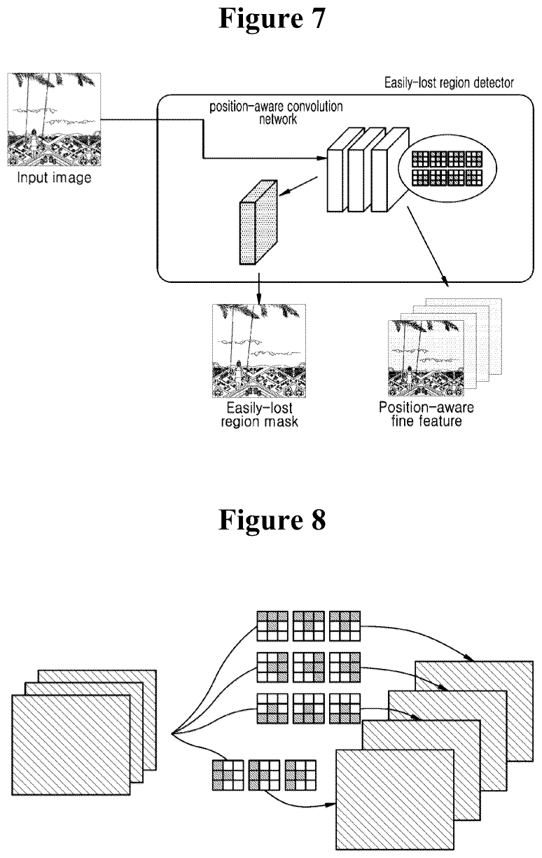

In order to solve the technical problem of poor segmentation of fine objects and object edges in the related art, an embodiment of the disclosure proposes an Easily-Lost Region Detector with Position-Aware Convolution (620), to detect easily-lost small objects and object edges, and may extract fine feature maps to represent the details of objects in the image. The easily-lost region detector (as shown in FIG. 7) may be a module composed of a lightweight neural network composed of a set of position-aware convolutions, which receives a target image (610) as input and outputs a set of masks (mask maps) representing positions of easily-lost regions and a set of feature maps (i.e., second feature maps, also referred to as fine feature maps) representing detailed information of an object. Compared with the features extracted by the feature extraction backbone network (which can be represented by the first feature map), the features extracted by the easily-lost region detector are more inclined to represent the position information (which can be represented by the mask map) and detailed information (such as texture, shape, etc., which can be represented by the second feature map) of the object. The features obtained by the easily-lost region detector can make up for the detail information of the object lost due to down-sampling by the feature extraction backbone network in the related art, and help to improve the segmentation effect of fine objects and object edges. The function of the easily-lost region detector can be completed by the position-aware convolution module, which is shown in FIG. 8.

As shown in FIG. 6, for the target image (610), two feature extraction operations can be performed in parallel, wherein one can be to perform feature extraction based on the backbone network (620) to obtain the first feature map (that is, the first feature map can be obtained by down-sampling to process the target image (610), and the other can be easily-lost object detector based on position-aware convolution (630). The Easily-lost object detector based on position-aware convolution (630) may be to perform feature extraction to obtain the mask map and the second feature map (that is, the mask map and the second feature map may be obtained by performing convolution on the target image).

Optionally, performing convolution on the target image (610), includes performing a convolution operation on the target image based on a convolution kernel. The convolution kernel may preset.

Wherein, the convolution kernel may be constituted from convolution kernels corresponding to different directions, and a direction for a convolution kernel is determined based on information points adjacent to a center point of a convolution kernel. For example, the convolution kernel may perform convolution operation on the target image based on convolution kernels corresponding to each direction. And, the each direction for the convolution kernels are determined based on information for adjacent points to center point of the convolution kernels.

In an embodiment, the direction of the convolution kernel is described with 3×3 convolution as an example: the output of 3×3 convolution is the weighted sum of 9 points, and in the embodiment of the application, it is considered that this convolution structure may not well store position information of a center point, and therefore, the embodiment of the disclosure proposes position-aware 3×3 convolution. However, the convolution kernel is not limited to a 3×3 size.

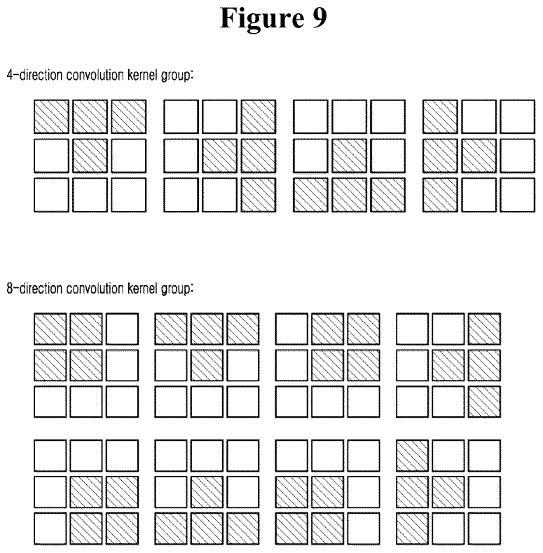

In this embodiment of the disclosure, the information of the center point and several consecutive neighbor points around the center point (information of points adjacent to the center point) can be used (if three neighbor points are used, there are information for a total of four points). On this basis, the convolution kernels can be formed into 4 or 8-direction convolution kernel group according to the different positions of the neighbor points (as shown in FIG. 9), and a corresponding convolution kernel group can form the position-aware convolution network of the embodiment of the disclosure. For the convolution kernels in different directions, the center point can focus on the neighbors at different positions, and the center point position appears in all the convolution kernels to improve the importance of the convolution kernel. The position information of the center point may be represented by using the convolution kernels in different directions. In actual use, a faster 4-direction convolution kernel, or a more accurate 8-direction convolution kernel can be selected according to the actual computational overhead requirements (as shown in FIG. 9). The position-aware convolution can not only well preserve the position information of the center point, and additionally, the 3×3 position-aware convolution has fewer parameters and computational overhead than the traditional 3×3 convolution. Besides, the position-aware convolution according to the embodiment of the disclosure may also be well optimized on devices such as GPUs.

The following is described below in conjunction with FIG. 6 and FIG. 7: for an input target image, it is respectively input into the feature extraction backbone network and the easily-lost region detector for feature extraction.

A set of first feature maps with decreasing resolution ( 1/1, ½, . . . , 1/16, 1/32 original image size) but increasing semantic information can be obtained through the feature extraction backbone network. The feature extraction backbone network may be any existing feature extraction network, which is not limited in this embodiment of the disclosure.

As shown in FIG. 6, the easily-lost object detector in the embodiment of the disclosure may be composed of a set of position-aware convolution in N directions plus M layers (as shown in FIG. 7, it may be position-aware convolution in 8 directions plus 3 layers, which is only used as an example here, and the values of N and M are not limited in this application). A mask map and a second feature map can be obtained by the easily-lost object detector, wherein the mask map can include a set of masks representing the position of the easily-lost regions, or the feature maps representing detailed information of object (i.e., second feature map or fine feature map). Including the mask map and the feature maps representing detailed information of object can make up for the object detail information and easily-lost position information lost by down-sampling based on the feature extraction backbone network, and help improve the semantic segmentation effect of fine objects and object edges.

The specific process for splitting the target image in the embodiment of the disclosure will be described below.

In an embodiment, in step S102, the target image is split to obtain at least one sub-image, including step A1-step A3.

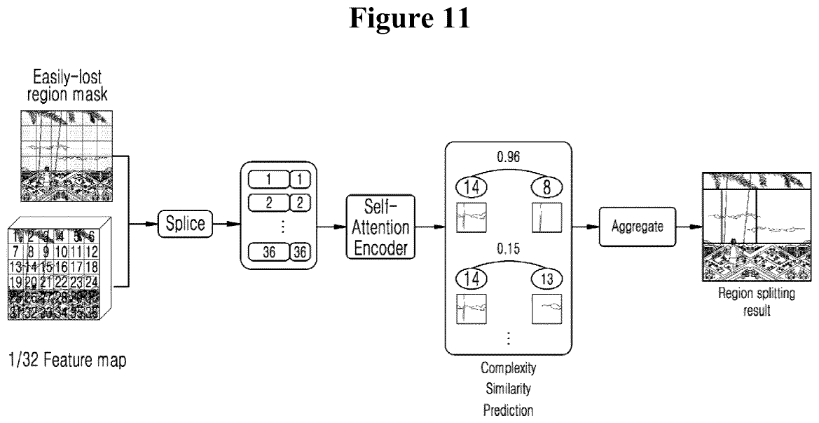

Step A1: splitting the target image to obtain a certain number of sub-images. Optionally, the target image may be split, based on a resolution of a first feature map obtained by down-sampling the target image, to obtain a certain number of sub-images. As shown in FIG. 11, each grid may correspond to one sub-image obtained by splitting.

As shown in FIG. 11, according to the resolution of the first feature map (such as 1/32), the target image can be evenly split into a certain number of sub-images, and each square sub-image represents a 32×32 pixel region in the original image (the target image), wherein in this embodiment of the disclosure, the input target image can be initialized as 36 basic square sub-images. Wherein, the number of square sub-images obtained by initialization is related to the resolution of the input target image (e.g., the target image obtained in step S101).

Optionally, the target image can also be split into sub-images in other shapes, and utilizing a square to carry out the splitting of target image in the embodiment of the disclosure is more conducive to the processing of subsequent aggregation, which, for example, may effectively reduce computational complexity etc.; but this embodiment of the application does not limit the shape of the sub-image.

Step A2: determining similarity between the sub-images.

The similarity between each sub-image and other sub-images is determined; as shown in FIG. 11, the similarity related to difficulty of semantic segmentation between grid (No. 1) and other grids (No. 2-36).

Wherein, each sub-image may include at least one pixel, and the similarity between the sub-images may be calculated based on the feature information of the pixel included in the sub-image and the feature information of the pixels included in other sub-images. Optionally, the similarity determined in step A2 may be related to content similarity in addition to the difficulty of semantic segmentation, and content similarity may be determined based on the similarity of features.

Optionally, in step A2, the determining the similarity between sub-images, includes following step A21-step A22.

Step A21: determining feature information corresponding to respective sub-images, based on the first feature image and a mask map obtained by performing convolution on the target image;

Step A22: determining similarities between each sub-image and other sub-images, based on the feature information corresponding to respective sub-images.

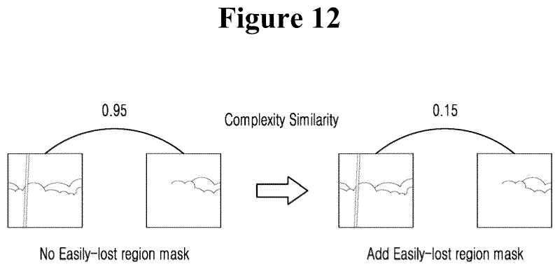

In an embodiment of the disclosure, for example, in step S102, when the similarity of segmentation difficulty is predicted, many sub-images that are easily confused can be distinguished only when the easily-lost region mask is added, and the accuracy of splitting the target image may be improved by using the mask map. As shown in FIG. 12, without the guidance of the easily-lost region mask, the semantic segmentation model easily ignores that the segmentation difficulty of sub-images containing both swing and sky is different from that of sub-images containing only sky. In FIG. 12, if the easily-lost region mask is not used, the complexity similarity of the two regions is predicted to be 0.95; after adding the synchronous combined mask map for prediction, the model predicts the complexity similarity of the two regions to be 0.15, which improves prediction accuracy, wherein, each region in FIG. 12 can be understood as a sub-image obtained by splitting the target image.

As shown in FIG. 11, each position in the first feature map represents the semantic feature of the sub-image in this region, and these features will be spliced together with the easily-lost region mask of the corresponding position as initial features of a dynamic grid generator (input features shown in FIG. 11). The segmentation difficulty similarity between each initial sub-image and all other sub-images can be obtained through a Self-Attention Encoder (complexity similarity prediction shown in FIG. 11). Wherein, the self-attention encoder can be a neural network based on Transformer encoder, and the attention value is obtained by performing dot product operation and normalization operation on a set of input features, and all features are weight-summed by the normalized attention value to recombine each feature, wherein the variable structure parameters of the self-attention encoder, such as the number of layers, the width, etc., are not limited in this embodiment of the disclosure.

Step A3: aggregating sub-images based on the similarity, to obtain at least one aggregated sub-image.

As shown in FIG. 11, the segmentation difficulty similarity between the 14th sub-image and the 8th sub-image is higher, which is 0.96; the segmentation difficulty similarity between the 14th sub-image and the 13th sub-image is lower, which is 0.15. According to the value of the similarity between the sub-images, any aggregation algorithm can be used, such as aggregating several evenly split sub-images into one sub-image.

Optionally, when the sub-images are aggregated, the number of sub-images obtained after the aggregation can also be set to be as few as possible, and the segmentation difficulty of sub-images obtained by splitting in step A1, included in the sub-images obtained by aggregation in step A3, may be set as similar as possible, and the size thereof can be different.

As shown in FIG. 11, in the target image, the sky region with simple content (simple segmentation difficulty) can be split together, and the branch with complex content (segmentation difficulty is larger) combined with the sky region can be split together. From the region splitting result, the input target image is split into 5 rectangular regions in total (aggregated from the initial 36 sub-images to the final 5 sub-images).

Optionally, in order to reduce computational complexity, the similarity between each sub-image and its adjacent sub-images can be calculated first, and if the similarity is lower than the preset threshold, it may not be necessary to further determine the similarity of other sub-images in the same direction. As shown in FIG. 11, if the similarity between the sub-image 26 and the sub-image 20 is lower than the preset threshold, it is not necessary to compute the similarity between the sub-image 26 and the sub-images 14, 8, and 2.

In an embodiment of the disclosure, as shown in FIG. 6, the dynamic grid generator (640) splits the target image (610) to be split into rectangular regions (sub-images or at least one sub-image) with different sizes and aspect ratios according to the degrees of segmentation difficulties, wherein the same rectangular region may be considered as the same segmentation difficulty of all pixels in the sub-image; and then the sub-images or the at least one sub-image (651, 652, 653, 654, 655) can be used as a whole to be fed into the predictor (650). As shown in FIG. 6, the input to the dynamic grid generator (640) can be the low-resolution feature map (such as 1/32 of the original image size) obtained by the backbone feature extraction network (620) in step S101 and the mask map obtained by the easily-lost object detector (630) (easily-lost region mask). Wherein, due to utilizing of the easily-lost region mask, the sky part containing the swing can be aggregated into a rectangular region, which effectively improves the accuracy of aggregation. As shown in FIG. 6 and FIG. 10, since respective aggregated sub-image are all input to the predictor (650) to select the resolution and decoder to be used, the smaller the number of sub-images are, the less computation the predictor needs to be performed. Compared with the initial sub-images with 1/32 of the original image size, the number of sub-images after aggregation is smaller, which can save the computation amount of the predictor.

The specific process for determining the semantic segmentation result in the embodiment of the disclosure will be described below.

After the operation of step S102, the target image (610) can be split into several rectangular regions (sub-images) with different sizes and aspect ratios, and these rectangular regions will be specified, by the predictor (650), with the required output resolution, and the width and depth corresponding to the decoder. Then, for each sub-image input to the decoder, each sub-image will be respectively input to the corresponding decoder (660-1, 660-2, 660-3) for prediction of image semantic segmentation. Wherein, the adopted sub-network of the decoder has the characteristic of weight sharing.

In an embodiment, in step S103, the determining a semantic segmentation result for a sub-image by a target decoder matching the sub-image, includes performing the prediction operations of step B1-step B2 for each sub-image.

Step B1: determining network information matching the sub-image, based on the feature information extracted from the sub-image.

The predictor network can be used to assign a decoder corresponding to the appropriate output resolution, and the depth and width of the decoder network according to the difficulty of semantic segmentation of different sub-images. For sub-images with simple semantic segmentation difficulty, a lower output resolution and a decoder with a simpler network structure can be used; for sub-images with complex content (high semantic segmentation difficulty), a higher output resolution and a decoder with a relatively complex network structure can be used. Therefore, the embodiment of the disclosure can effectively improve the resource utilization efficiency of the semantic segmentation of the target image, and reduce unnecessary waste of resources.

Optionally, the step of determining network information matching the sub-image, based on the feature information extracted from the sub-image in step B1 includes following step B11-step B13.

Step B11: extracting a predicted feature of the sub-image.

The feature information of the sub-image can be extracted through the feature extraction layer included in the set predictor.

Wherein, the step of extracting the prediction feature of the sub-image in step

B11 can include following step B111-step B113.

Step B111: converting a certain number of corresponding features in the first feature map obtained by down-sampling the target image (610), into a pooling feature, based on position information about the sub-image in the target image (610).

Step B112: predicting semantic probability distribution feature of the sub-image.

Step B113: determining a shape feature of the sub-image based on the size of the sub-image.

The pooling feature, the semantic probability distribution feature, and the shape feature constitute the predicted feature of the sub-image.

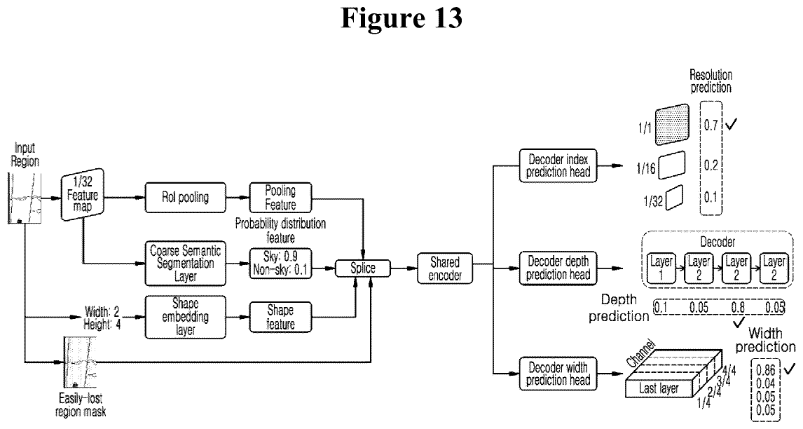

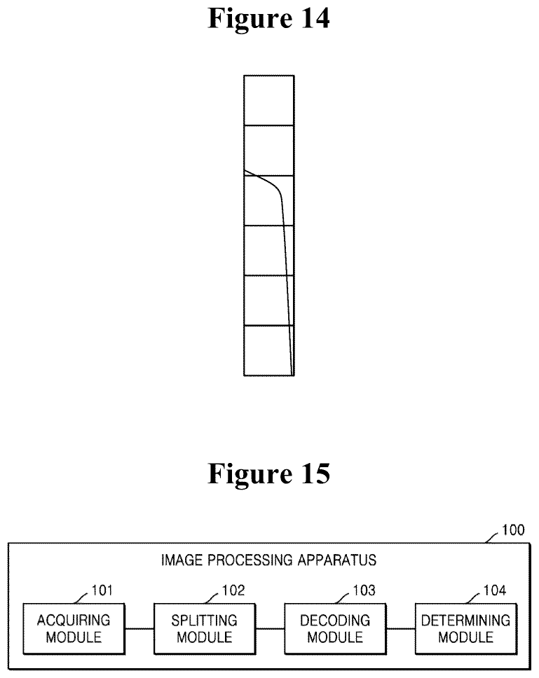

As shown in FIG. 13, the feature extraction layer may be composed of a ROI pooling layer (region of interest pooling layer), a coarse semantic segmentation layer, and a shape embedding layer. The feature extraction layer is used to construct the corresponding features for a sub-image based on the input.

Wherein, according to the position of the input sub-image in the target image, the ROI pooling layer can convert several feature vectors representing the sub-image on the first feature map (such as a 1/32 feature map) into a feature vector (the pooled feature shown in FIG. 13) to facilitate the processing of the shared encoder connected to the feature extraction layer in a subsequent predictor, and the converted feature vector can provide the high-level semantic information captured by the feature extraction backbone network.

Wherein, the coarse semantic segmentation layer performs semantic prediction for the input sub-image, and provides semantic probability distribution feature corresponding to the sub-image, so as to use the semantic probability distribution feature as the semantic supplement of the pooling feature. As shown in FIG. 13, in the embodiment of the disclosure, the semantic probability distribution features of the input region predicted by the coarse semantic segmentation layer are sky as 0.9 and non-sky as 0.1.

Wherein, the shape embedding layer takes the width and height of the input region as input, and converts the width and height information into shape feature vectors. As shown in FIG. 13, the input region in this embodiment of the disclosure has a height of 4 and a width of 2 at a resolution of 1/32. Since that the shape of an object is a very important semantic feature, the shape feature vector can further enhance the semantic information of the input region. As shown in FIG. 14, the region formed by a pole is usually slender and requires high output resolution and a more complex decoder, and this kind feature related to object shape characteristics can be represented by the width and height of the sub-image.

The feature extraction layer includes three sub-layers, that is, a ROI pooling layer, a coarse semantic segmentation layer, and a shape embedding layer. After the corresponding features are extracted through the three sub-layers, as shown in FIG. 13, the three extracted features are spliced to obtain the predicted features corresponding to the sub-images, which are used as the input of the shared encoder connected to the feature extraction layer.

Step B12: determining an encoding feature of the sub-image, based on the predicted feature and a mask map obtained by performing convolution on the target image.

As shown in FIG. 13, the sub-images may be feature encoded by the shared encoder included in the predictor. Wherein, the input of the shared encoder includes predicted features and easily-lost region masks; wherein, the feature input of the entire predictor is composed of the three features (the pooling feature, semantic probability distribution feature, and shape feature) obtained by the feature extraction layer and the easily-lost region mask, and these information may be spliced and input into the encoder connected after the feature extraction layer. Encoding feature of the sub-image may be described as encoding information.

Wherein, the network structure of the encoder in the predictor is not limited in the embodiment of the application, and can be an arbitrary multilayer perceptron or a convolution neural network, etc., which is responsible for encoding the input feature of the predictor (650), and outputting encoded features corresponding to the sub-image.

Step B13: determining the network information matching the sub-image based on the encoding feature, wherein the network information includes at least one of the output resolution, the number of layers, or the number of channels of the network.

The encoding features obtained by encoding of the encoder will be delivered to the decoder prediction head, as shown in FIG. 13, and the decoder prediction head may include a decoder index prediction head, a decoder width prediction head, and a decoder depth prediction head, which respectively output the decoder corresponding to the output resolution required by the input region and the network structure of the decoder (such as the width of the last layer and the depth of the decoder, that is, the number of channels and layers).

The structure of the decoder prediction head is not limited in the embodiment of the disclosure, and may be any multi-layer perceptron or convolution neural network or the like.

Wherein, the outputs of the above-mentioned three prediction heads are all a probability distribution, and the position with the largest output probability represents the prediction of the prediction head. In the embodiment of the disclosure, as shown in FIG. 13, for the input region, there are the following three types of network information output by the predictor.

The prediction for the output resolution of the sub-image by the decoder index prediction head is: 1/1 resolution probability is 0.7, 1/16 resolution probability is 0.2, 1/32 resolution probability is 0.1; 1/1 with the highest probability can be selected as the output resolution.

The depth prediction of the decoder used by the decoder depth prediction head for the sub-image is (in the example shown in FIG. 13, the decoder is set to a maximum of 4 layers): the probability of layer 1 is 0.1, the probability of layer 2 is 0.05, the probability of layer 3 is 0.8, and the probability of layer 4 is 0.05; layer 3 with the highest probability can be selected as the depth of the decoder used for the sub-image.

The width prediction of the decoder required by the decoder width prediction head for the sub-image is: the probability of using ¼ channels is 0.05, the probability of using 2/4 channels is 0.05, and the probability of using ¾ channels is 0.04, and the probability of using 4/4 channels is 0.86; the 4/4 channel number with the highest probability can be selected as the width of the last layer of the decoder used for the sub-image; that is, the probability of predicting to use 4/4 decoder channels (i.e., all decoder channels) in the embodiment of the disclosure is the greatest.

Adapting the example shown in FIG. 13, for this input region, it is predicted to use a decoder super-network at 1/1 output resolution, the depth of the decoder used is 3 layers, and the decoder use all channels for the last layer.

In the embodiment of the disclosure, only three resolution decoders are shown to solve the problems existing in the related art, but in fact, according to the custom settings and diversity of target images, it can be set to adopt more or less decoders for different resolutions. For example, it may set to use decoders with resolutions of 1/1, ½, ¼, ⅛, 1/16, 1/32; or for more complex target images, it may use more decoders to perform processing.

Step B2: predicting the semantic segmentation result for the sub-image, by the target decoder corresponding to the network information.

In order to save hardware resource overhead, by using a weigh sharing scheme for a decoder network in the embodiment of the disclosure, the complete decoder may be divided into different sub-networks based on the depth (number of layers) and width (number of channels) thereof, as shown in FIG. 10. Since the common parts of these sub-networks share a network weight, the total number of parameters of these sub-networks is equal to the number of parameters of the largest sub-network (that is, the complete decoder network), and the number of parameters will not increase as the number of sub-networks increases. The target decoder can be described as a decoder.

On this basis, when different sub-networks are used to predict semantic segmentation results for sub-images, different inputs can be used. Wherein, the step of predicting the semantic segmentation result for the sub-image in step B2 includes the following step B21.

Step B21: predicting the semantic segmentation result for the sub-image by combining a second feature map obtained by performing convolution on the target image, if an output resolution corresponding to the sub-image is identical with the resolution of the target image (610). Optionally, if the output resolution corresponding to a sub-image is lower than the resolution of the target image, the semantic segmentation result for the sub-image can be directly predicted without performing prediction processing in combination with the second feature map.

As shown in FIG. 10, the input target image of the embodiment of the disclosure is split into 5 sub-images by step S102, and then, the corresponding output resolution and the depth and width of the decoder network can be matched for different sub-images, which is illustrated in the following three cases combined with FIG. 10.

For the two sky regions with low segmentation difficulty (simple regions), it only needs to use the first feature map with 1/32 resolution as input. For the decoder super-network corresponding to 1/32 resolution, the maximum depth in this embodiment of the disclosure is two layers, and the maximum number of channels is 128. For two simple sub-images, there is no need to use the full decoder network, which only uses one of the layers (the first layer shown by the solid line), and ¾ of the number of channels, i.e., 96.

For regions of moderate segmentation difficulty (regions of moderate difficulty), it uses the first feature map at 1/16 output resolution, and the first two layers in the decoder super-network corresponding to 1/16, wherein the last layer uses ½ of the number of channels.

For the region (complex region) with high segmentation difficulty, it not only uses the first feature map at high original image resolution, but also uses fine features (the second feature map) obtained by the easily-lost region detector in step S101 as input. It uses the first three layers of the decoder super-network corresponding to 1/1 resolution, and the last layer uses the full number of channels 512.

In an embodiment of the disclosure, only 3 output resolutions and corresponding decoder super-networks are used, and for more complex input target images, the number of the output resolutions and corresponding decoder super-networks used may be more. Due to utilizing of decoders with different complexity and output resolutions for different sub-images, the computation amount can be greatly reduced for simple regions, and the segmentation accuracy is also guaranteed; for complex regions, due to the addition of fine features and using a larger output resolution and a more complex decoder, although the amount of computation is increased, better segmentation accuracy can be obtained. The embodiment of the disclosure achieves a balance between performance and resource overhead through better resource allocation.

The specific process of determining the semantic segmentation result for the target image based on a semantic segmentation result for a sub-image in the embodiment of the disclosure will be described below.

In an embodiment, the step of determining a semantic segmentation result for the target image based on the semantic segmentation result for the sub-image in step S104 includes step C1.

Step C1: combining the semantic segmentation results for the respective sub-images, to obtain the semantic segmentation result for the target image.

Optionally, the combining of the semantic segmentation results of the sub-images can be completed by means of image splicing, and finally the semantic segmentation result for the target image are obtained.

Wherein, before combining the semantic segmentation results for the respective sub-images, the following step C2 is further included.

Step C2: up-sampling the semantic segmentation result for the sub-image to the resolution of the target image, if the resolution corresponding to the semantic segmentation result for the sub-image is less than the resolution of the target image.

Through the decoder, a corresponding semantic segmentation result may be obtained for each sub-image, and if the output resolution used by the sub-image is lower than the resolution of the original image, the semantic segmentation result for the sub-image is required to be up-sampled until its output resolution is the same as that of the original image.

Finally, the semantic segmentation results of respective sub-image can be spliced together to obtain the final semantic segmentation result for the target image (the sky segmentation result shown in FIG. 6).

In an embodiment of the disclosure, the provided image processing method belongs to a content-aware dynamic network segmentation method, which adopts a predictor-based dynamic decoder network and an easily-lost region detector. The problem of poor resource allocation is effectively solved by the dynamic decoder network. On this basis, the easily-lost region detector can be combined to improve the accuracy of the output semantic segmentation results.

The embodiment of the disclosure provides an image processing apparatus. As shown in FIG. 15, the image processing apparatus 100 may include: an acquiring module 101, a splitting module 102, a decoding module 103, and a determining module 104.

Wherein, the acquiring module 101 is configured to acquire a target image; the splitting module 102 is configured to split the target image to obtain at least one sub-image; the decoding module 103 is configured to determine a semantic segmentation result for a sub-image by a target decoder matching the sub-image; and the determining module 104 is configured to determine a semantic segmentation result for the target image based on the semantic segmentation result for the sub-image.

In an embodiment, when configured to split the target image to obtain at least one sub-image, the splitting module 102 is specifically configured to:
split the target image to obtain a certain number of sub-images;
determine similarity between the sub-images; and
aggregate sub-images based on the similarity, to obtain at least one aggregated sub-image.

In an embodiment, when configured to split the target image to obtain a certain number of sub-images, the splitting module 102 is configured to:

split the target image, based on a resolution of a first feature map obtained by down-sampling the target image, to obtain a certain number of sub-images.

In an embodiment, when configured to determine similarity between sub-images, the splitting module 102 is specifically configured to:
determine feature information corresponding to respective sub-images, based on the first feature image and a mask map obtained by performing convolution on the target image;
determine similarities between each sub-image and other sub-images, based on the feature information corresponding to respective sub-images.

In an embodiment, when configured to determine a semantic segmentation result for a sub-image by a target decoder matching the sub-image, the decoding module 103 is specifically configured to:

perform the following prediction operations for each sub-image:

determine network information matching the sub-image, based on the feature information extracted from the sub-image; and
predict the semantic segmentation result for the sub-image, by the target decoder corresponding to the network information.

In an embodiment, when configured to determine network information matching the sub-image, based on the feature information extracted from the sub-image, the decoding module 103 is specifically configured to:
extract a predicted feature of the sub-image;
determine an encoding feature of the sub-image, based on the predicted feature and a mask map obtained by performing convolution on the target image; and

determine the network information matching the sub-image based on the encoding feature, wherein the network information includes at least one of resolution, the number of layers, or the number of channels of the network.

In an embodiment, when configured to extract a predicted feature of the sub-image, the decoding module 103 is specifically configured to:
convert a certain number of corresponding features in the first feature map obtained by down-sampling the target image, into a pooling feature, based on position information about the sub-image in the target image;
predict semantic probability distribution feature of the sub-image; and
determine a shape feature of the sub-image based on the size of the sub-image, wherein the pooling feature, the semantic probability distribution feature, and the shape feature constitute the predicted feature of the sub-image.

In an embodiment, when configured to predict a semantic segmentation result for a sub-image, the decoding module 103 is configured to:
predict the semantic segmentation result for the sub-image by combining a second feature map obtained by performing convolution on the target image, if an output resolution corresponding to the sub-image is identical with the resolution of the target image.

In an embodiment, the step of performing convolution on the target image includes: performing a convolution operation on the target image based on a preset convolution kernel, wherein, the preset convolution kernel is constituted from convolution kernels corresponding to different directions, and a direction for a convolution kernel is determined based on information points adjacent to a center point of a convolution kernel.

In an embodiment, when configured to determine a semantic segmentation result for the target image based on the semantic segmentation result for the sub-image, the determining module 104 is configured to:
combine the semantic segmentation results for the respective sub-images, to obtain the semantic segmentation result for the target image.

In an embodiment, when configured to combine the semantic segmentation results for the respective sub-images, the determining module 104 is configured to:
up-sample the semantic segmentation result for the sub-image to the resolution of the target image, if the resolution corresponding to the semantic segmentation result for the sub-image is less than the resolution of the target image.

The apparatus of the embodiments of the disclosure can perform the methods provided by the embodiments of the disclosure, and the implementation principles thereof are similar. The actions performed by the various modules in the apparatus of the embodiments of the disclosure correspond to the steps in the methods of the embodiments of the disclosure. For a detailed functional description of the various modules of the apparatus, reference can be made in particular to the description of the corresponding methods shown in the foregoing description, which will not be repeated here.

The embodiment of the disclosure provides an electronic device, including a memory, a processor, and a computer program stored in the memory. The processor executes above-mentioned computer program to realize the steps of image processing method, and compared with the related art, to achieve: the target image may be split to obtain at least one sub-image after acquiring a target image, which implementing of this step may group parts with similar semantic segmentation difficulties in the target image into a same sub-image; then a semantic segmentation result for a sub-image is determined by a target decoder matching the sub-image, and finally a semantic segmentation result for the target image is determined based on the semantic segmentation result for the sub-image; in embodiments of the step, respective corresponding semantic segmentation results may be determined by adopting different decoders with respect to different sub-images, and therefore the semantic segmentation result for the target image may be determined according to the semantic segmentation results for respective sub-images, which this operation may significantly improve resource utilization efficiency of the semantic segmentation for the target image and reduce unnecessary waste of resources.

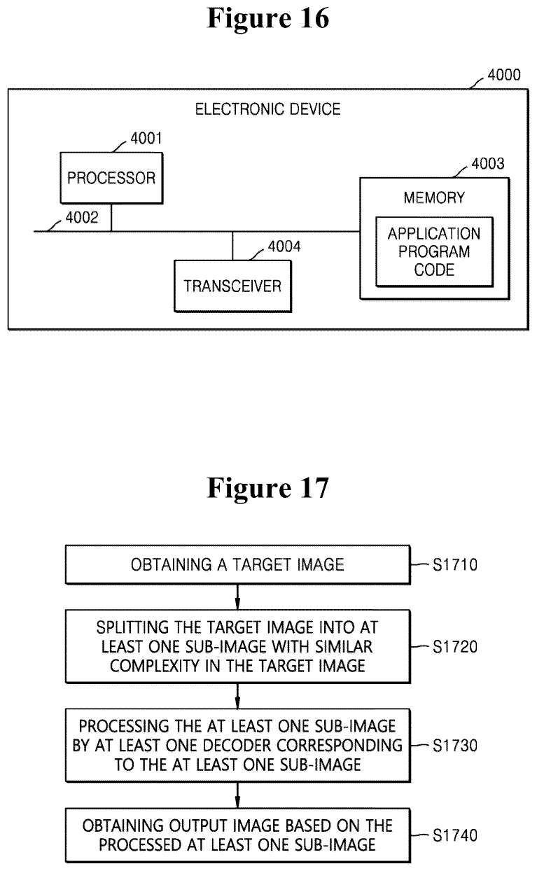

In an optional embodiment, an electronic device is provided, as shown in FIG. 16. The electronic device 4000 shown in FIG. 16 includes: a processor 4001 and a memory 4003. The processor 4001 and the memory 4003 are connected, for example, via a bus 4002. Optionally, the electronic device 4000 may further include a transceiver 4004, and the transceiver 4004 may be configured for data interaction between the electronic device and other electronic devices, such as data transmission and/or data reception. It should be noted that the transceiver 4004 is not limited to one in actual application, and the structure of the electronic device 4000 is not limited to the embodiment of the disclosure.

The processor 4001 may be a central processing unit (CPU), a general-purpose processor, a digital signal processor (DSP), an application specific integrated circuit (ASIC), a field programmable gate array (FPGA) or other programmable logic devices, a transistor logic device, a hardware component or any combination thereof. The processor can implement or execute various exemplary logic blocks, modules and circuits described in the disclosure of the present invention. The processor 4001 may also be a combination for realizing computing functions, for example, a combination of one or more microprocessors, a combination of DSPs and microprocessors, etc.

The bus 4002 can include a path for delivering information among the above components. The bus 4002 may be a Peripheral Component Interconnect (PCI) bus or an Extended Industry Standard Architecture (EISA) bus or the like. The bus 4002 may be classified into address bus, data bus, control bus, etc. For ease of illustration, only one bold line is shown in FIG. 16, but does not indicate that there is only one bus or type of bus.

The memory 4003 may be a read only memory (ROM) or other types of static storage devices that can store static information and instructions, a random access memory (RAM) or other types of storage devices that can store information and instructions. The memory 4003 may also be electrically erasable programmable read only memory (EEPROM), compact disc read only memory (CD-ROM) or other optical disk storage, optical disk storage (including compressed compact disc, laser disc, compact disc, digital versatile disc, blue-ray disc, etc.), magnetic disk storage medium or other magnetic storage device, or any other medium capable of carrying or storing computer programs and capable of being accessed by a computer, but not limited to this.

The memory 4003 is used to store computer programs for executing embodiments of the disclosure and is controlled for execution by the processor 4001. The processor 4001 is configured to execute the computer program stored in the memory 4003 to implement the contents shown in any of the foregoing method embodiments.

The apparatus provided in the embodiment of the disclosure may implement at least one module among the plurality of modules through an AI model. The functions associated with AI may be performed through a non-volatile memory, a volatile memory, and a processor.

The processor may include one or more processors. In this case, the one or more processors may be a general purpose processor, (e.g., a central processing unit (CPU), an application processor (AP), etc.), or a pure graphics processing unit, (e.g., a graphics processing unit (GPU), a visual processing unit (VPU), and/or an AI-specific processor, (e.g., a neural processing unit (NPU))).

The one or more processors control processing of the input data according to predefined operating rules or artificial intelligence (AI) models stored in the non-volatile memory and the volatile memory. Predefined operating rules or artificial intelligence models are provided through training or learning.

Here, “providing through learning” refers to obtain a predefined operation rule or an AI model having desired features by applying a learning algorithm to multiple learning data. The learning may be performed in the apparatus itself in which AI according to the embodiments are executed, and/or may be realized by a separate server/system.

The AI model may include multiple neural network layers. Each layer has multiple weight values, and the computation of one layer is performed by the computation result of the previous layer and the multiple weights of the current layer. Examples of neural networks include but are not limited to a convolutional neural network (CNN), a deep neural network (DNN), a recurrent neural network (RNN), a restricted Boltzmann machine (RBM), a deep belief network (DBN), a bidirectional recurrent deep neural network (BRDNN), a generative adversarial network (GAN), and a deep Q network.

A learning algorithm is a method of training a predetermined target device (e.g., a robot) using multiple learning data to enable, allow, or control the target device to make a determination or prediction. Examples of the learning algorithm include but are not limited to supervised learning, unsupervised learning, semi-supervised learning, or reinforcement learning.

In an embodiment, in operation S1710, the electronic device (4000) may obtain a target image (610). For example, the electronic device may receive an image from another electronic device, or may obtain a target image stored in the electronic device. It may be performed in the same or similar manner as in S101. The obtaining of a target image is not limited to the disclosed example.

In an embodiment, the resolution of the target image may be down-sampled while passing through the backbone network for processing the target image.

In an embodiment, the electronic device (4000) may obtain feature information associated with position of fine object by performing convolution on the target image by a mask map easily-lost object detector (630). The feature information may include a mask map indicating the location of area that can be easily lost, or fine feature maps indicating fine features of the target image. Feature information may be input to dynamic grid generator (640), predictor (650), or decoder (660-1, 660-2, or 660-3).

In an embodiment, in operation S1720, the electronic device (4000) may include splitting the target image into at least one sub-image with similar complexity in the target image. For example, the target image processed in the backbone network may be split.

In an embodiment, the electronic device (4000) may split the target image into at least one grid of equal size. For example, the electronic device (4000) may split the target image into 36 grid as shown FIG. 11. For example, the target image at the bottom left of FIG. 11 is divided into 36 grids of equal size. The electronic device (4000) may determine similarity of complexity between adjacent grids in the at least one grid. For example, the electronic device may compute the similarity of the complexity between adjacent grids based on the feature information and self-attention network. The other detailed description about computing the similarity of the complexity is omitted since it is disclosed in the description of FIG. 11.

In an embodiment, the electronic device (4000) may group the at least one grid into the at least one sub-image based on the similarity of the complexity between the each adjacent grid. For example, the electronic device (4000) identifying whether the similarity of the complexity between the adjacent grids is greater than or equal to a threshold. And, the electronic device (4000) may identify whether a shape obtained by merging the adjacent grids is rectangle based on identifying that the similarity of the complexity between the adjacent grids is greater than or equal to the threshold. The electronic device (4000) may determine to group the adjacent grids based on that the shape is rectangle. For example, the electronic device may group some grid (grid 7, 13, and 19) in FIG. 11 into a first sub-image (651). The electronic device may group some grid (grid 10, 11, 12, 16, 17, 18, 22, 23, and 24) in FIG. 11 into a second sub-image (652). The electronic device may group some grid (grid 1 to 6) in FIG. 11 into a third sub-image (653). The electronic device may group some grid (grid 25 to 36) in FIG. 11 into a fourth sub-image (654). The electronic device may group some grid (grid 8, 9, 14, 15, 20, and 21) into a fifth sub-image (655). The grouping algorithm is not limited to this.

In an embodiment, in operation S1730, the electronic device (4000) may process the at least one sub-image by at least one decoder corresponding to the at least one sub-image.

In an embodiment, the electronic device (4000) may determine encoding information corresponding to each of the at least one sub-image. The encoding information may comprises at least one of pooling feature, semantic probability distribution feature, or shape feature of the sub-image. And, the encoding information may be spliced information in FIG. 13 to be provided to the shared encoder. The electronic device (4000) may determine network information for the at least one decoder corresponding to each of the at least one sub-image based on the encoding information. The network information may be information including which decoder each sub-image should be input to. For example, the network information may include information that the first sub-image (651) and the second sub-image (652) should be input to the decoder 1/32 (660-1). The network information may include information that the third sub-image and the fourth sub-image should be input to the decoder 1/16 (660-2). The network information may include information that the fifth sub-image should be input to the decoder 1/1 (660-3).

In an embodiment, in operation S1740, the electronic device (4000) may obtain output image (670) based on the processed at least one sub-image. For example, the output image may be obtained by appropriately up-sampling, and then combining decoded sub-images according to the resolution of sub-images. For example, the electronic device (4000) may up-sample the decoded first sub-image and the decoded second sub-image to 32x scale. And, the electronic device (4000) may up-sample the decoded third sub-image and the decoded fourth sub-image to 16x scale. And, the electronic device may merge or combine all of the up-sampled sub-images (the first to fourth sub-images) and the fifth sub-image. The finally merged image may be the output image (670).

In an embodiment, an image processing method may be provided. The method may comprise obtaining a target image (610) (S1710). The method may comprise splitting the target image (610) into at least one sub-image with similar complexity in the target image (S1720). The method may comprise processing the at least one sub-image (651, 652, 653, 654, 655) by at least one decoder (660-1, 660-2, 660-3) corresponding to the at least one sub-image (S1730). The method may comprise obtaining output image (670) based on the processed at least one sub-image (S1740).

In an embodiment, the method may comprise splitting the target image (610) into at least one grid of equal size. The method may comprise determining similarity of complexity between adjacent grids in the at least one grid. The method may comprise grouping the at least one grid into the at least one sub-image (651, 652, 653, 654, 655) based on the similarity of the complexity between the each adjacent grid.

In an embodiment, the method may comprise obtaining feature information associated with position of fine object by performing convolution on the target image (610). The method may comprise computing the similarity of the complexity between adjacent grids based on the feature information and self-attention network.

In an embodiment, the feature information may comprise a mask map indicating the location of area that can be easily lost, or fine feature maps indicating fine features of the target image.

In an embodiment, the method may comprise identifying whether the similarity of the complexity between the adjacent grids is greater than or equal to a threshold. The method may comprise identifying whether a shape obtained by merging the adjacent grids is a rectangle based on identifying that the similarity of the complexity between the adjacent grids is greater than or equal to the threshold. The method may comprise determining to group the adjacent grids based on that the shape is a rectangle.

In an embodiment, the method may comprise determining encoding information corresponding to each of the at least one sub-image (651, 652, 653, 654, 655). The method may comprise determining network information for the at least one decoder (660-1, 660-2, 660-3) corresponding to each of the at least one sub-image (651, 652, 653, 654, 655) based on the encoding information.

In an embodiment, the network information may comprise at least one of the output resolution, the number of layers, or the number of channels of network.

In an embodiment, the encoding information may comprise at least one of pooling feature, semantic probability distribution feature, or shape feature of the sub-image.

In an embodiment, the method may comprise performing convolution operation on the target image (610) based on convolution kernels corresponding to each direction. The each direction for the convolution kernels are determined based on information for adjacent points to center point of the convolution kernels.

In an embodiment, an electronic device (4000) for image processing is provided. The electronic device (4000) may comprise a memory (4003) storing one or more instructions, and at least one processor (4001) configured to execute the one or more instructions. The at least one processor (4001) may be configured to obtain a target image (610). The at least one processor (4001) may be configured to split the target image (610) into at least one sub-image (651, 652, 653, 654, 655) with similar complexity in the target image. The at least one processor (4001) may be configured to process the at least one sub-image (651, 652, 653, 654, 655) by at least one decoder (660-1, 660-2, 660-3) corresponding to complexity of the at least one sub-image (651, 652, 653, 654, 655). The at least one processor (4001) may be configured to obtain output image (670) based on processed at least one sub-image.

In an embodiment, the at least one processor (4001) may be configured to split the target image (610) into at least one grid of equal size. The at least one processor (4001) may be configured to determine similarity of the complexity between adjacent grids in the at least one grid. The at least one processor (4001) may be configured to group the at least one grid into the at least one sub-image (651, 652, 653, 654, 655) based on the similarity of the complexity between the each adjacent grid.

In an embodiment, the at least one processor (4001) may be configured to obtain feature information associated with a position of a fine object by performing convolution on the target image (610). The at least one processor (4001) may be configured to compute the similarity of the complexity between adjacent grids based on the feature information and self-attention network.

In an embodiment, the at least one processor (4001) may be configured to determine encoding information corresponding to each of the at least one sub-image (651, 652, 653, 654, 655). The at least one processor (4001) may be configured to determine network information for the at least one decoder corresponding to each of the at least one sub-image (651, 652, 653, 654, 655) based on the encoding information.

In an embodiment, the at least one processor (4001) may be configured to perform convolution operation on the target image (610) based on convolution kernels corresponding to each direction, The each direction for the convolution kernels may be determined based on information for adjacent points to center point of the convolution kernels.

In an embodiment, a computer-readable storage medium in which a computer program for executing, an image processing method is provided. The image processing method may include obtaining a target image. The image processing method may include splitting the target image into at least one sub-image with similar complexity in the target image. The image processing method may include processing the at least one sub-image by at least one decoder corresponding to the at least one sub-image. The image processing method may include obtaining output image based on the processed at least one sub-image.

In an embodiment, an image processing method may comprise acquiring a target image. The image processing method may comprise splitting the target image to obtain at least one sub-image. The image processing method may comprise determining a semantic segmentation result for a sub-image by a target decoder matching the sub-image. The image processing method may comprise determining a semantic segmentation result for the target image based on the semantic segmentation result for the sub-image.

In an embodiment, the image processing method may comprise splitting the target image to obtain a certain number of sub-images. The image processing method may comprise determining similarity between the sub-images. The image processing method may comprise aggregating sub-images based on the similarity, to obtain at least one aggregated sub-image.

In an embodiment, the image processing method may comprise splitting the target image, based on a resolution of a first feature map obtained by down-sampling the target image, to obtain a certain number of sub-images.

In an embodiment, the image processing method may comprise determining feature information corresponding to respective sub-images, based on the first feature image and a mask map obtained by performing convolution on the target image. The image processing method may comprise determining similarities between each sub-image and other sub-images, based on the feature information corresponding to respective sub-images.

In an embodiment, the image processing method may comprise performing the following prediction operations for each sub-image. The image processing method may comprise determining network information matching the sub-image, based on the feature information extracted from the sub-image. The image processing method may comprise predicting the semantic segmentation result for the sub-image, by the target decoder corresponding to the network information.

In an embodiment, the image processing method may comprise extracting a predicted feature of the sub-image. The image processing method may comprise determining an encoding feature of the sub-image, based on the predicted feature and a mask map obtained by performing convolution on the target image. The image processing method may comprise determining the network information matching the sub-image based on the encoding feature, wherein the network information comprises at least one of the output resolution, the number of layers, or the number of channels of the network.

In an embodiment, the image processing method may comprise converting a certain number of corresponding features in the first feature map obtained by down-sampling the target image, into a pooling feature, based on position information about the sub-image in the target image. The image processing method may comprise predicting semantic probability distribution feature of the sub-image. The image processing method may comprise determining a shape feature of the sub-image based on the size of the sub-image, wherein the pooling feature, the semantic probability distribution feature, and the shape feature constitute the predicted feature of the sub-image.

In an embodiment, the image processing method may comprise predicting the semantic segmentation result for the sub-image by combining a second feature map obtained by performing convolution on the target image, if an output resolution corresponding to the sub-image is identical with the resolution of the target image.

In an embodiment, the image processing method may comprise performing a convolution operation on the target image based on a preset convolution kernel. The preset convolution kernel may be constituted from convolution kernels corresponding to different directions, and a direction for a convolution kernel is determined based on information points adjacent to a center point of a convolution kernel.

In an embodiment, the image processing method may comprise combining the semantic segmentation results for the respective sub-images, to obtain the semantic segmentation result for the target image.

In an embodiment, up-sampling the semantic segmentation result for the sub-image to the resolution of the target image, if the resolution corresponding to the semantic segmentation result for the sub-image is less than the resolution of the target image.

In an embodiment, an image processing apparatus may comprise an acquiring module, configured to acquire a target image, a splitting module, configured to split the target image to obtain at least one sub-image, a decoding module, configured to determine a semantic segmentation result for a sub-image by a target decoder matching the sub-image, a determining module, configured to determine a semantic segmentation result for the target image based on the semantic segmentation result for the sub-image.

In an embodiment, an electronic device may comprise a memory, a processor and a computer program stored on the memory, wherein the processor executes the computer program to implement the steps of the image processing method of the disclosure.

In an embodiment, a computer-readable storage medium in which a computer program is stored, wherein the computer program implements, when executed by a processor, the image processing method of the disclosure.

In an embodiment, a computer program product, comprising a computer program, wherein the computer program implements, when executed by a processor, the image processing method of the disclosure.

Embodiments of the disclosure provide a computer-readable storage medium having a computer program stored on the computer-readable storage medium, the computer program, when executed by a processor, implements the steps and corresponding contents of the foregoing method embodiments.

Embodiments of the disclosure also provide a computer program product including a computer program, the computer program when executed by a processor realizing the steps and corresponding contents of the preceding method embodiments.

The terms “first”, “second”, “third”, “fourth”, “1”, “2”, etc. (if any) in the specification and claims of the present invention and the accompanying drawings are used for distinguishing similar objects, rather than describing a particular order or precedence. It should be understood that the used data can be interchanged if appropriate, so that the embodiments of the present invention described herein can be implemented in an order other than the orders illustrated or described with text.

It should be understood that, although various operational steps are indicated by arrows in the flowcharts of embodiments of the disclosure, the order in which the steps are performed is not limited to the order indicated by the arrows. Unless explicitly stated herein, in some implementation scenarios of embodiments of the present disclosure, the implementation steps in the respective flowcharts may be performed in other order as required. In addition, some or all of the steps in each flowchart may include multiple sub-steps or multiple stages based on actual implementation scenarios. Some or all of these sub-steps or stages may be executed simultaneously, and each of these sub-steps or stages may also be executed at different times respectively. The order of execution of these sub-steps or stages can be flexibly configured according to requirements in different scenarios of execution time, and the embodiments of the disclosure are not limited thereto.

The above-mentioned description is merely an alternative embodiment for some implementation scenarios of the disclosure, and it should be noted that it would have been within the scope of protection of embodiments of the disclosure for those skilled in the art to adopt other similar implementation means based on the technical idea of the disclosure without departing from the technical concept of the solution of the disclosure.

What is claimed is:

1. An image processing method, comprising:
obtaining a target image;
splitting the target image into at least one sub-image based on a similarity of complexity in the target image;
processing the at least one sub-image by at least one decoder corresponding to the at least one sub-image; and
obtaining an output image based on the processed at least one sub-image.

2. The method of claim 1, wherein the splitting of the target image into the at least one sub-image comprises:
splitting the target image into at least one grid of equal size;
determining the similarity of the complexity between adjacent grids among the at least one grid; and
grouping the at least one grid into the at least one sub-image based on the similarity of the complexity between the adjacent grids.

3. The method of claim 2, wherein the determining the similarity of the complexity between the adjacent grids comprises:
obtaining feature information associated with a position of a fine object by performing convolution on the target image; and
determining the similarity of the complexity between the adjacent grids based on the feature information and self-attention network.

4. The method of claim 3, wherein the feature information comprises a mask map indicating at least one of a location of an easily-lost region, and fine feature maps indicating fine features of the target image.

5. The method of claim 2, wherein the grouping the at least one grid into the at least one sub-image comprises:
identifying whether the similarity of the complexity between the adjacent grids is greater than or equal to a threshold;
identifying whether a shape obtained by merging the adjacent grids is a rectangle based on identifying that the similarity of the complexity between the adjacent grids is greater than or equal to the threshold; and
grouping the adjacent grids based on the shape being a rectangle.

6. The method of claim 1, wherein the processing the at least one sub-image comprises:
determining encoding information corresponding to each of the at least one sub-image; and
determining network information for the at least one decoder corresponding to each of the at least one sub-image based on the encoding information.

7. The method of claim 6, wherein the network information comprises at least one of an output resolution, a number of layers, and a number of channels of network.

8. The method of claim 6, wherein the encoding information comprises at least one of a pooling feature, a semantic probability distribution feature, and a shape feature of the at least one sub-image.

9. The method of claim 3, wherein the obtaining the feature information associated with the position of the fine object comprises:
performing a convolution operation on the target image based on convolution kernels corresponding to each direction, and
wherein the each direction for the convolution kernels are determined based on information of adjacent points and a center point of the convolution kernels.

10. An electronic device for image processing, comprising:
a memory storing one or more instructions; and
at least one processor configured to execute the one or more instructions to:
obtain a target image;
split the target image into at least one sub-image based on a similarity of complexity in the target image;
process the at least one sub-image by at least one decoder corresponding to a complexity of the at least one sub-image; and
obtain an output image based on the at least one processed sub-image.

11. The electronic device of claim 10, wherein the at least one processor is further configured to:
split the target image into at least one grid of equal size;
determine the similarity of the complexity between adjacent grids among the at least one grid; and
group the at least one grid into the at least one sub-image based on the similarity of the complexity between the adjacent grids.

12. The electronic device of claim 11, wherein the at least one processor is further configured to:
obtain feature information associated with a position of a fine object by performing convolution on the target image; and
determine the similarity of the complexity between the adjacent grids based on the feature information and a self-attention network.

13. The electronic device of claim 10, wherein the at least one processor is further configured to:
determine encoding information corresponding to each of the at least one sub-image; and
determine network information for the at least one decoder corresponding to each of the at least one sub-image based on the encoding information.

14. The electronic device of claim 12, wherein the at least one processor is further configured to:
perform a convolution operation on the target image based on convolution kernels corresponding to each direction, and
wherein the each direction of the convolution kernels is determined based on information of adjacent points and a center point of the convolution kernels.

15. A non-transitory computer-readable storage medium in which a computer program for executing, the method of claim 1.
